(19) United States
(12) Patent Application Publication
(10) Pub. No.: US 2008/0250034 A1
(43) Pub. Date: Oct. 9, 2008

(54) EXTERNAL METADATA ACQUISITION AND SYNCHRONIZATION IN A CONTENT MANAGEMENT SYSTEM

(76) Inventor: John Edward Petri, Lewiston, MN (US)

Correspondence Address: MARTIN & ASSOCIATES, LLC, P.O. BOX 548, CARTHAGE, MO, 64836-0548, US

(21) Appl. No.: 11/697,463

(22) Filed: Apr. 6, 2007

(51) Int. Cl. G06F 17/00

(52) U.S. Cl. 707/100; 707/E17.005

(57) ABSTRACT

A content management system (CMS) allows a CMS administrator to access data from an external source, such as a web page, and to correlate the external data with an attribute for a document type. When a user authors a document of that type in the CMS, the user may select from a picklist that includes values retrieved from the external data source. A metadata acquisition policy associated with the attribute may specify one or more criteria for determining if and when changes to the external data source should be automatically reflected in the attribute, and if notifications of changes to the external data should be provided to a CMS administrator.

### BACKGROUND

1. Technical Field

This disclosure generally relates to content management systems, and more specifically relates to a content management system that acquires metadata for a document attribute from a source external to the content management system.

2. Background Art

A content management system (CMS) allows many users to efficiently share electronic content such as text, audio files, video files, pictures, graphics, etc. Content management systems typically control access to content in a repository. A user may generate content, and when the content is checked into the repository, the content is checked by the CMS to make sure the content conforms to predefined rules. A user may also check out content from the repository, or link to content in the repository while generating content. The rules in a CMS assure that content to be checked in or linked to meets desired criteria specified in the rules.

Known content management systems check their rules when content is being checked in. If the rule is satisfied, the content is checked into the repository. If the rule is not satisfied, the content is not checked into the repository. Known content management systems may include rules related to bursting, linking, and synchronization. Bursting rules govern how a document is bursted, or broken into individual chunks, when the document is checked into the repository. By bursting a document into chunks, the individual chunks may be potentially reused later by a different author. Linking rules govern what content in a repository a user may link to in a document that will be subsequently checked into the repository. Synchronization rules govern synchronization between content and metadata related to the content. For example, a synchronization rule may specify that whenever a specified CMS attribute is changed, a particular piece of XML in the content should be automatically updated with that attribute's value.

Documents in a CMS include metadata that relates to the content. In a known CMS, a user specifies metadata for a document while drafting the document. Metadata may also be populated automatically by the CMS based on other attributes or document content within the CMS. Recent developments provide a user with a picklist of available metadata values, allowing the user to pick one of the values in the picklist. However, known content management systems cannot dynamically update values in the picklist when an external data source changes, and cannot perform one or more functions when a change in an external data source is detected. Without a way to use metadata from a source external to the CMS in a way that allows the CMS to automatically monitor changes to the data and to perform one or more functions in response to a detected change in the data at the external source, known content management systems will not be able to detect changes to external data and perform corresponding functions when the external data changes.

### BRIEF SUMMARY

A content management system (CMS) allows a CMS administrator to access data from an external source, such as a web page, and to correlate the external data with an attribute for a document type. When a user authors a document of that type in the CMS, the user may select from a picklist that includes values retrieved from the external data source. A metadata acquisition policy associated with the attribute may specify one or more criteria for determining if and when changes to the external data source should be automatically reflected in the attribute, and if notifications of changes to the external data should be provided to a CMS administrator.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a networked computer system that includes a server computer system that has a content management system that includes an external metadata acquisition mechanism;

FIG. 2 is a flow diagram of a prior art method for a user to manually define metadata during the drafting of a document;

FIG. 3 is a flow diagram of a prior art method for a user to pick metadata values from a picklist during the drafting of a document;

FIG. 4 is a flow diagram of a method for specifying external metadata to build a picklist of values for an attribute in a specified document type in the content management system;

FIGS. 5 and 6 are different portions of the same flow diagram of a method for synchronizing data in the document type attribute with data in the external data source;

FIG. 7 shows a first sample document in a content management system;

FIG. 8 shows a sample metadata acquisition policy;

FIG. 9 shows a second sample document in a content management system;

FIG. 10 shows the document 900 in FIG. 9 after the value of the schema_number is updated to 4.6 due to a change of the schema number at the external data source; and

FIG. 11 shows a new document 1100 that may be automatically generated in the CMS based on a major release of the schema at the external data source.

### DETAILED DESCRIPTION

The claims and disclosure herein provide a content management system (CMS) that allows defining metadata in a document in the CMS that specifies a data source that is external to the CMS, and further allow automatically updating the attribute in one or more documents in the CMS when the value of specified external metadata changes.

Many known content management systems use extensible markup language (XML) due to its flexibility and power in managing diverse and different types of content. One known content management system that uses XML is Solution for Compliance in a Regulated Environment (SCORE) developed by IBM Corporation. XML is growing in popularity, and is quickly becoming the preferred format for authoring and publishing. While the disclosure herein discusses XML documents as one possible example of content that may be managed by a content management system, the disclosure and claims herein expressly extend to content management systems that do not use XML.

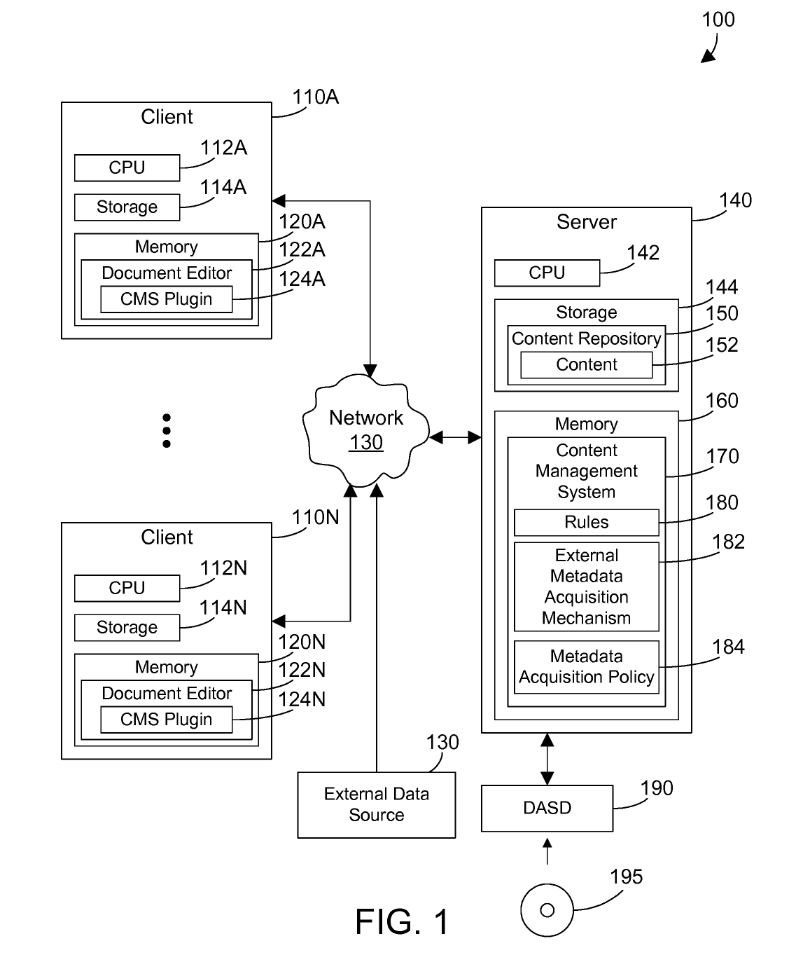

Referring to FIG. 1, networked computer system 100 includes multiple clients, shown in FIG. 1 as clients 110A, . . . , 110N, coupled to a network 130. Each client preferably includes a CPU, storage, and memory that contains a document editor and a content management system (CMS) plugin. Thus, client 110A includes a CPU 112A, storage 114A, memory 120A, a document editor 122A in the memory 120A that is executed by the CPU 112A, and a CMS plugin 124A that allows the document editor 122A to interact with content 152 in the repository 150 that is managed by the CMS 170 in server 140. In similar fashion, other clients have similar components shown in client 110A, through client 110N, which includes a CPU 112N, storage 114N, memory 120N, a document editor 122N, and a CMS plugin 124N.

The CMS 170 resides in the main memory 160 of a server computer system 140 that also includes a CPU 142 and storage 144 that includes a content repository 150 that holds content 152 managed by the CMS 170. One example of a suitable server computer system 140 is an IBM eServer System i computer system. However, those skilled in the art will appreciate that the disclosure herein applies equally to any type of client or server computer systems, regardless of whether each computer system is a complicated multi-user computing apparatus, a single user workstation, or an embedded control system. CMS 170 includes rules 180, an external metadata acquisition mechanism 182, and a metadata acquisition policy 184. Rules 180 may include bursting rules, linking rules, and synchronization rules. Of course, other rules, whether currently known or developed in the future, could also be included in rules 180. External metadata acquisition mechanism 182 is used to retrieve data from a source external to the CMS 170 and its associated repository 150, such as from external data source 130 shown in FIG. 1. External data source 130 represents any suitable source of data that is not controlled by the CMS 170. One suitable example of an external data source 130 is a web page accessible via the internet. The metadata acquisition policy 184 specifies one or more criteria that determine how the external metadata acquisition mechanism 182 functions.

In FIG. 1, repository 150 is shown separate from content management system 170. In the alternative, repository 150 could be within the content management system 170. Regardless of the location of the repository 150, the content management system 170 controls access to content 152 in the repository 150.

Server computer system 140 may include other features of computer systems that are not shown in FIG. 1 but are well-known in the art. For example, server computer system 140 preferably includes a display interface, a network interface, and a mass storage interface to an external direct access storage device (DASD) 190. The display interface is used to directly connect one or more displays to server computer system 140. These displays, which may be non-intelligent (i.e., dumb) terminals or fully programmable workstations, are used to provide system administrators and users the ability to communicate with server computer system 140. Note, however, that while a display interface is provided to support communication with one or more displays, server computer system 140 does not necessarily require a display, because all needed interaction with users and other processes may occur via the network interface.

The network interface is used to connect the server computer system 140 to multiple other computer systems (e.g., 110A, . . . , 110N) via a network, such as network 130. The network interface and network 130 broadly represent any suitable way to interconnect electronic devices, regardless of whether the network 130 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

The mass storage interface is used to connect mass storage devices, such as a direct access storage device 190, to server computer system 140. One specific type of direct access storage device 190 is a readable and writable CD-RW drive, which may store data to and read data from a CD-RW 195.

Main memory 160 preferably contains data and an operating system that are not shown in FIG. 1. A suitable operating system is a multitasking operating system known in the industry as i5/OS; however, those skilled in the art will appreciate that the spirit and scope of this disclosure is not limited to any one operating system. In addition, server computer system 140 utilizes well known virtual addressing mechanisms that allow the programs of server computer system 140 to behave as if they only have access to a large, single storage entity instead of access to multiple, smaller storage entities such as main memory 160, storage 144 and DASD device 190. Therefore, while data, the operating system, and content management system 170 may reside in main memory 160, those skilled in the art will recognize that these items are not necessarily all completely contained in main memory 160 at the same time. It should also be noted that the term “memory” is used herein generically to refer to the entire virtual memory of server computer system 140, and may include the virtual memory of other computer systems coupled to computer system 140.

CPU 142 may be constructed from one or more microprocessors and/or integrated circuits. CPU 142 executes program instructions stored in main memory 160. Main memory 160 stores programs and data that CPU 142 may access. When computer system 140 starts up, CPU 142 initially executes the program instructions that make up the operating system.

Although server computer system 140 is shown to contain only a single CPU, those skilled in the art will appreciate that a content management system 170 may be practiced using a computer system that has multiple CPUs. In addition, the interfaces that are included in server computer system 140 (e.g., display interface, network interface, and DASD interface) preferably each include separate, fully programmed microprocessors that are used to off-load compute-intensive processing from CPU 142. However, those skilled in the art will appreciate that these functions may be performed using I/O adapters as well.

At this point, it is important to note that while the description above is in the context of a fully functional computer system, those skilled in the art will appreciate that the content management system 170 may be distributed as an article of manufacture in a variety of forms, and the claims extend to all suitable types of computer-readable media used to actually carry out the distribution, including recordable media such as floppy disks and CD-RW (e.g., 195 of FIG. 1).

The external metadata acquisition mechanism may also be delivered as part of a service engagement with a client corporation, nonprofit organization, government entity, internal organizational structure, or the like. This may include configuring a computer system to perform some or all of the methods described herein, and deploying software, hardware, and web services that implement some or all of the methods described herein. This may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

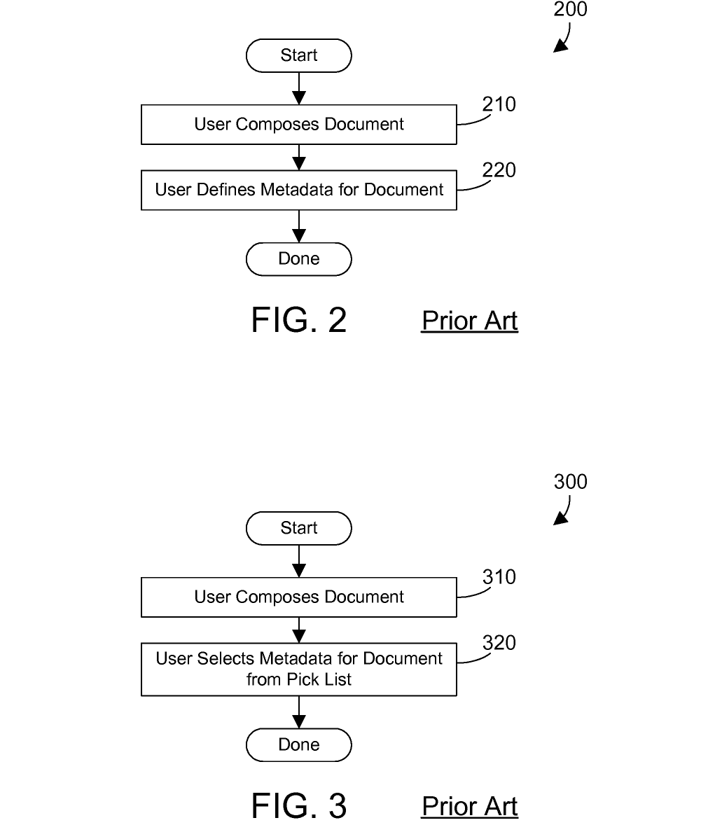

Referring to FIG. 2, a prior art method 200 shows how a user may create a document from scratch in a known content management system. The user composes the document (step 210). The user also defines the metadata for the document (step 220). Recent advances allow a user to pick metadata from a list rather than manually defining the metadata in step 220. In method 300 in FIG. 3, a user composes the document (step 310), and selects metadata for the document from a picklist (step 320). Making metadata selection available via a picklist increases ease of a user defining metadata. However, the prior art offers no way to update values of metadata in the CMS when the value of an external data source changes.

The external metadata acquisition mechanism and method disclosed herein allows a CMS administrator to browse an external data source and select one or more elements to correspond to a defined attribute in a document in the CMS. Values of the selected element(s) are then displayed in a picklist to a user composing a document. A metadata acquisition policy corresponds to the attribute, and specifies one or more criteria that determine how the external metadata may be used and whether or not the attribute in the document should be automatically updated with changes to the value of the metadata in the source external to the CMS.

From the perspective of the CMS, it is acquiring metadata when it allows a CMS administrator to go to an external data source and select one or more elements as the source for data for a defined attribute. The CMS is acquiring a value for its metadata (the attribute) from the external data source, so the data in the external data source is properly called “metadata” from the perspective of the CMS. Note, however, that there is nothing special in terms of format or data type that distinguishes data from metadata in a general sense. Any suitable data may serve as input to the CMS, and when such data is input to the CMS, its value may become the value of corresponding metadata in the CMS.

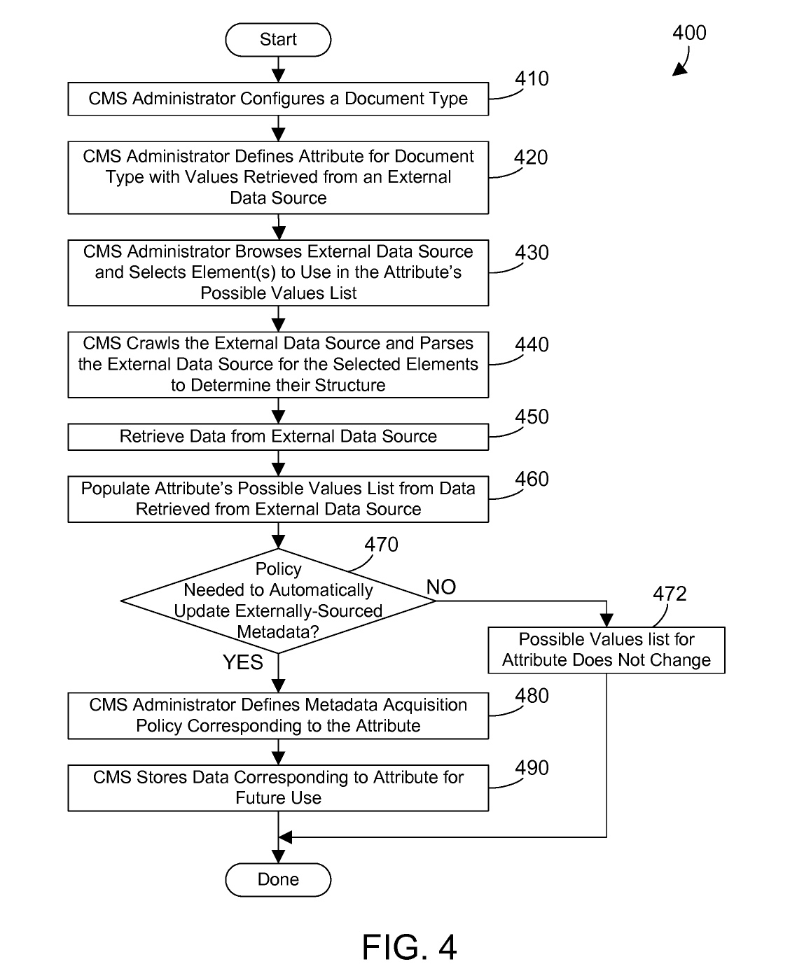

Referring to FIG. 4, a method 400 allows a CMS administrator to setup the use of metadata from an external source in a content management system. The CMS administrator configures a document type (step 410). The CMS administrator then defines an attribute for the document type, and specifies that values for that attribute should be retrieved from an external source, namely the external data source (step 420). The CMS administrator then browses the external data source and selects one or more elements to use in the attribute's possible values list (step 430). For example, the CMS administrator could browse to a web page, then click on an element in the web page to link the element's value to the value of the attribute in the document. The CMS then crawls the external data source and parses the external data source for the selected elements to determine their structure (step 440). Data corresponding to the selected elements is then retrieved from the external data source (step 450). The attribute's possible values list is then populated from the data retrieved from the external data source (step 460). If no policy is needed to automatically update the externally-sourced metadata (step 470=NO), the possible values list for the attribute will not change (step 472), but will stay the same as when the data was initially retrieved in step 450. If a policy is needed to automatically update the externally-sourced metadata (step 470=YES), the CMS administrator defines a metadata acquisition policy corresponding to the attribute (step 480). The CMS then stores data corresponding to the attribute for future use (step 490). Examples of suitable data corresponding to the attribute that could be stored in step 490 include a web page, a Uniform Resource Locator (URL) for the page, and structures from the page.

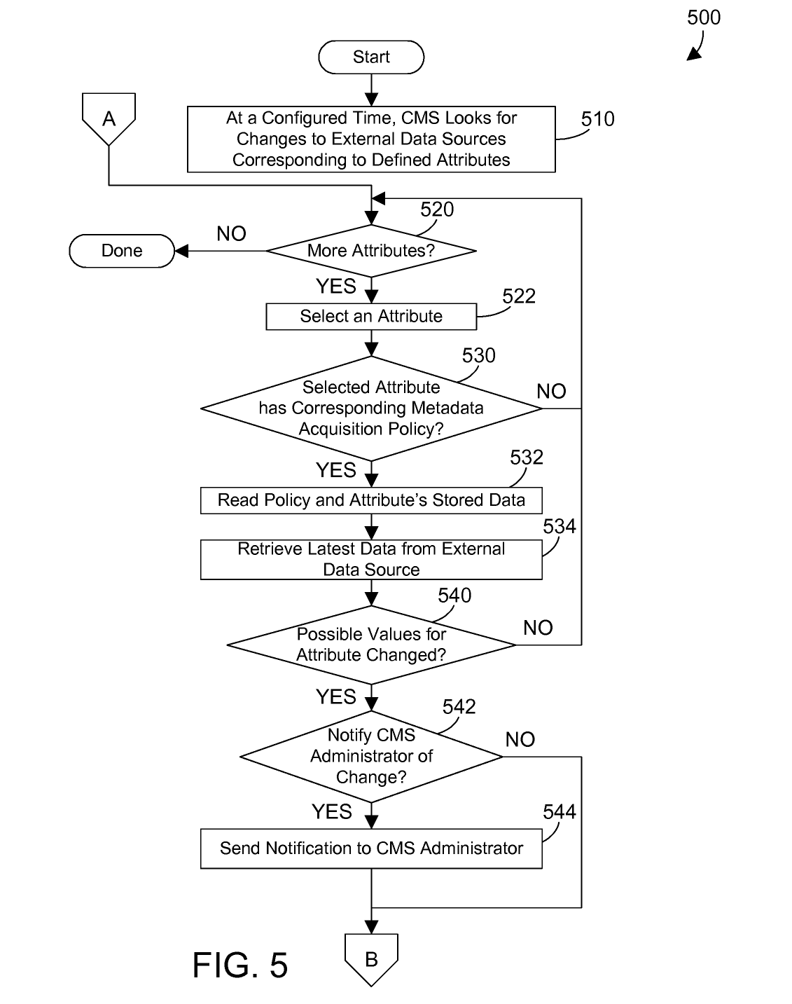

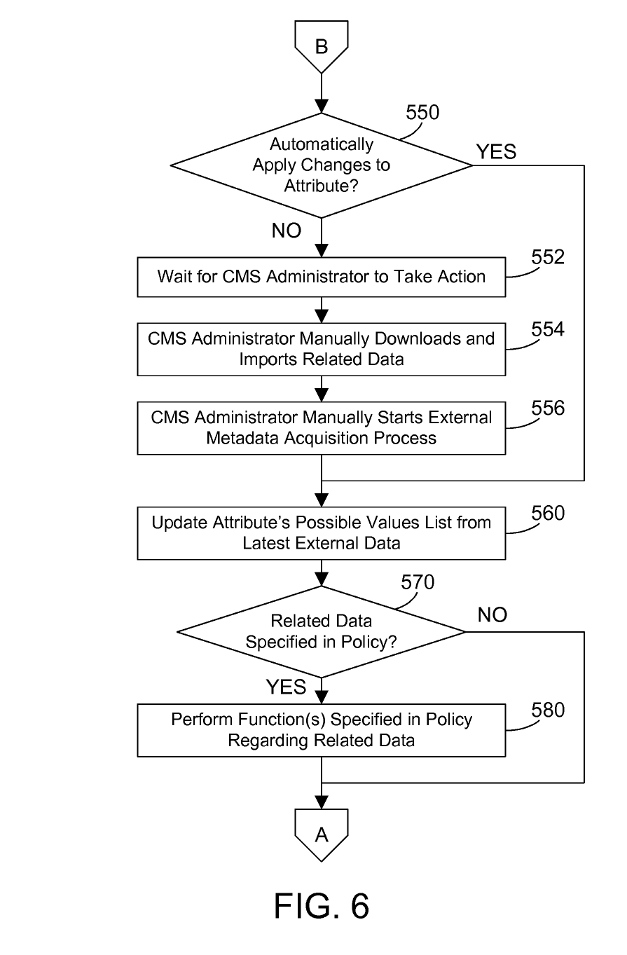

Referring to FIGS. 5 and 6, a method 500 determines whether values for externally-sourced metadata have changed, and if so, whether the changed values should be synchronized with attributes in documents in the CMS repository. At a configured time, the CMS looks for changes to the external data sources corresponding to defined attributes (step 510). Note the configured time in step 510 could be a time when explicitly requested by a CMS administrator or user, or could be a periodic time (e.g., once a week) for checking the external data source for changes. There are more attributes to process (step 520=YES), so one of the attributes is selected (step 522). If the selected attribute does not have a corresponding metadata acquisition policy (step 530=NO), method 500 loops back to step 520 and continues. If the selected attribute does have a corresponding metadata acquisition policy (step 530=YES), the corresponding policy and the data stored in step 490 in FIG. 4 is read (step 532). The latest data is retrieved from the external data source (step 534). If none of the values in the attribute's list of possible values changed (step 540=NO), method 500 loops back to step 520 and continues. If one or more values in the attribute's list of possible values changed (step 540=YES), method 500 determines from the attribute's corresponding metadata acquisition policy whether to notify the CMS administrator of the change (step 542). If the metadata acquisition policy specifies to notify the CMS administrator of the change (step 542=YES), a notification is sent (step 544). Otherwise, (step 542=NO), no notification is sent. Control then passes to marker B in FIG. 6. If the metadata acquisition policy specifies to automatically apply the changes in the values of the external data source to the attribute (step 550=YES), the attribute's possible values list is automatically updated from the latest external data (step 560). If the metadata acquisition policy specifies not to automatically apply the changes in the values of the external metadata (step 550=NO), method 500 waits for the CMS administrator to take action (step 552) by manually downloading and importing the related data (step 554) and manually starting the external metadata acquisition process (step 556). The attribute's possible values list is then updated from the latest external data (step 560). If there is related data specified in the metadata acquisition policy (step 570=YES), specified functions in the policy are then performed with respect to the related data (step 580). If there is no related data specified in the metadata acquisition policy (step 570=NO), step 580 is bypassed, and control passes to marker A in FIG. 5. Method 500 repeats until there are no more attributes to process (step 520=NO), at which point method 500 is done.

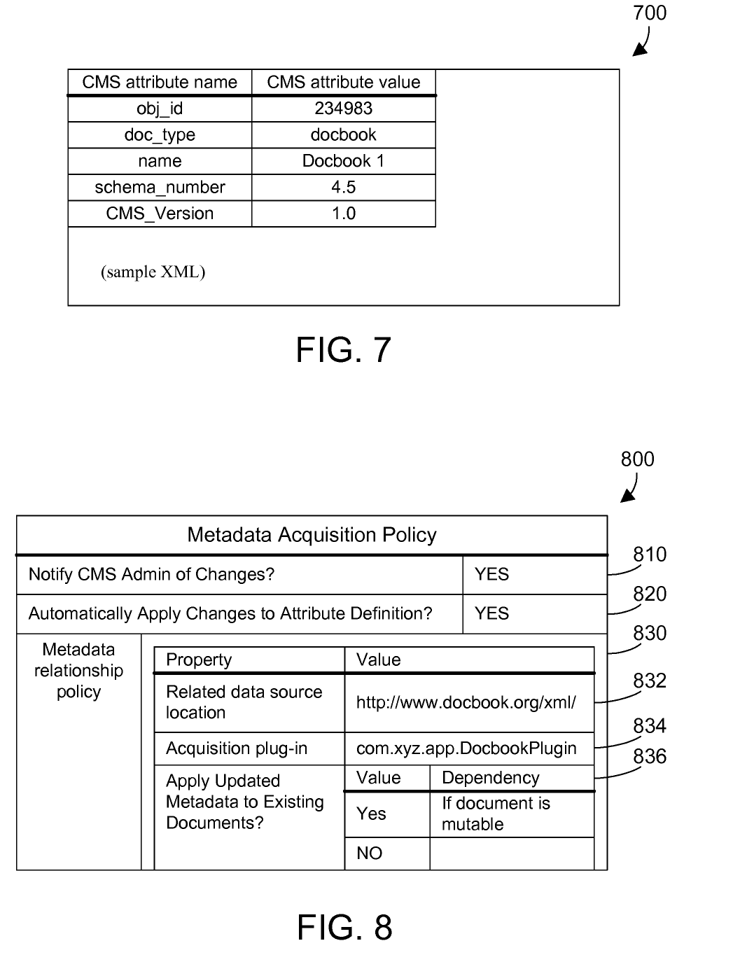

A simple example is now given to illustrate the function of methods 400 in FIG. 4 and 500 in FIGS. 5 and 6 in an example scenario. Referring to FIG. 4, we assume a CMS administrator configures a document type called docbook (step 410), then defines a schema_number attribute for the document type that is configured for externally acquired metadata (step 420). Other metadata is defined for document 700 in FIG. 7 from within the CMS, and includes an obj_id that is used to uniquely identify the document 700 in the CMS, a name of Docbook 1, and a CMS_Version of 1.0. The sample XML for document 700 is not shown in FIG. 7, but could be any suitable XML. We assume the CMS administrator browses a web page and selects an element on the web page that displays a schema number that corresponds to the schema for document 700 (step 430). The CMS crawls the web page and parses the source for the selected element corresponding to the schema number to determine the structure of the selected element (step 440). We assume the schema number in step 440 is defined in a simple HTML tag. The data corresponding to the selected element is then retrieved (step 450), and the attribute's possible values list is populated from the retrieved data (step 460). We assume for this example a policy is needed to automatically update the externally-selected schema number (step 470=YES), so the CMS administrator defines the metadata acquisition policy 800 shown in FIG. 8 (step 480). We assume the CMS or the CMS administrator also stores the URL for the web page and the structure of the selected element in a table for future use (step 490).

Metadata acquisition policy 800 specifies to notify the CMS administrator of any changes to the externally-acquired metadata in entry 810. Policy 800 also specifies to automatically apply changes to the attribute definition in entry 820. A metadata relationship policy is also specified in entry 830 that indicates a related data source location in entry 832, an acquisition plug-in in entry 834, and conditions in entry 836 that determine whether to apply updated data to existing documents.

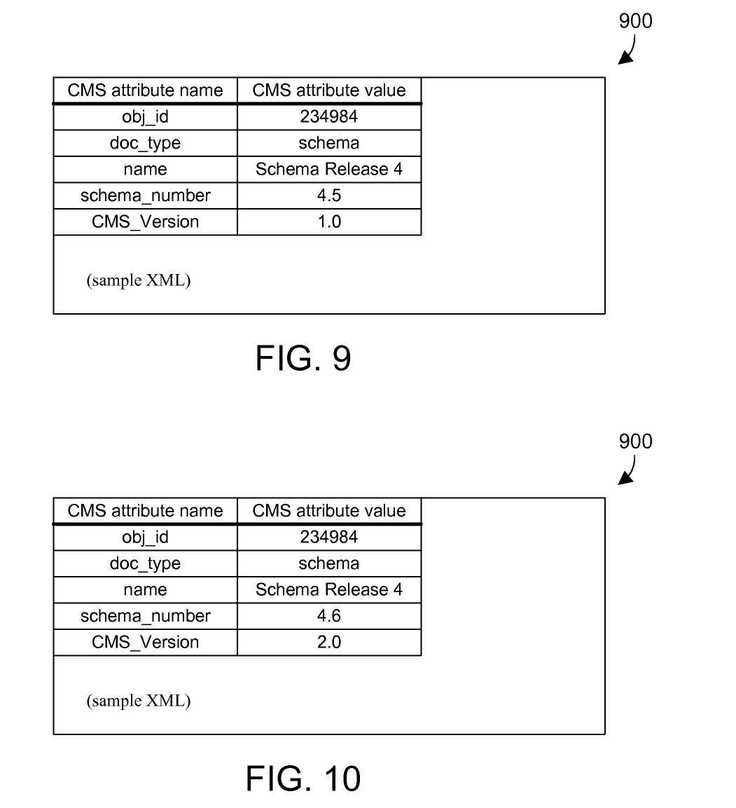

We assume the document 900 in FIG. 9 is an example schema document that was imported into the CMS according to the defined schema document type. The CMS can use the schema_number attribute to relate schema documents to documents of other types, such as docbook documents. Let's assume for this example that the docbook document 700 in FIG. 7 is related to the schema document 900 in FIG. 9 via the schema_number attribute, and has a floating relationship, meaning that whenever the schema document moves to a new major CMS version (e.g., changes from 1.0 to 2.0), the relationship link from the docbook document to the schema will automatically point to the new major version of the schema. The alternative to a floating relationship is a fixed or “locked down” relationship, which means the relationship link will not be changed when the schema document moves to a new major CMS version. In other words, the relationship will always point to the same fixed version of the schema.

Now let's assume the value for the element on the external web page that was selected to correspond to the schema_number attribute changes from 4.5 to 4.6. We assume for this example a change of the number after the decimal is a minor version change, while a change of the number before the decimal is a major version change. We now consider how method 500 in FIGS. 5 and 6 addresses this change. At a configured time, the CMS looks at the web page with the selected element that corresponds to the schema_number attribute (step 510). There are more attributes to process (step 520=YES), so the schema_number attribute is selected (step 522). The selected schema_number attribute has a corresponding metadata acquisition policy 800 shown in FIG. 8 (step 530=YES). The policy 800 is read, along with the URL and selected element for the external data source that was stored in step 490 of FIG. 4 (step 532). The latest data is retrieved from the selected element in the web page (step 534), which is 4.6. The possible values for the attribute changed (step 540=YES), and the policy 800 specifies to notify the CMS administrator of the change in entry 810 in FIG. 8 (step 542=YES), so the CMS administrator is notified of the change (step 544). Control now passes to marker B in FIG. 6. The policy 800 specifies to automatically apply the changes to the attribute in entry 820 (step 550=YES), so the attribute's possible values list is updated from the latest external data (step 560). This means the value of 4.6 is automatically added as a possible value in the picklist for the schema_number attribute in document 700. There is related data in the policy in entry 830 (step 570=YES), so the functions specified in entry 830 are performed (step 580). The metadata acquisition policy 800 includes an entry 830 that specifies an acquisition plug-in called com.xyz.app.DocbookPlugin. We assume for this example this plug-in specifies that minor changes to the schema_number may be incorporated directly into the applicable document type, and may be used to update corresponding documents in the repository. We further assume the plug-in specifies that changes to the schema_number require the schema to be imported into the repository, which may be done manually by a CMS administrator or automatically. Control now passes to marker A in FIG. 5. Because the schema_number attribute is the only attribute in document 700 in FIG. 7 that is derived from an external data source, there are no more attributes to process (step 520=NO), and method 500 is done.

In document 900 in FIG. 10, the schema_number has been updated to 4.6 to reflect the change in the value in the external data source from 4.5 to 4.6. In addition, we assume the 4.6 version of the schema document was imported into the repository (either manually or automatically) and so document 900 in FIG. 10 now also has a new CMS version of 2.0. The relationship between the docbook document 700 and schema document 900 will now point to CMS version 2.0 of document 900. This is possible because the relationship between the schema 900 in FIG. 9 and the document 700 in FIG. 7 is a “floating” relationship, meaning the relationship link will always point to the current CMS version of schema document 900. Note if a docbook document was bound to Schema Release 4 and CMS version 1.0 by a fixed, or “locked down” relationship, then the relationship link would not move to the newer CMS version 2.0 (i.e., the docbook document would keep pointing at Schema Release 4 and CMS version 1.0.

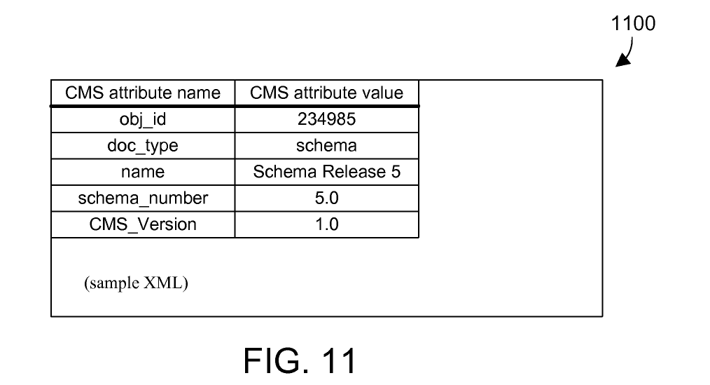

Now let's say that the schema number on the external data source changes to 5.0. Since it is a major version change it will be imported as its own object in the repository, as specified in the acquisition plug-in in entry 830 in FIG. 8. The new schema document is shown as document 1100 in FIG. 11. The document 700 in FIG. 7 with the obj_id of 234983 will continue to be related to the document named Schema Release 4 with the obj_id of 234984. Docbook 1 will only have its schema number and relationship changed to point to the newer schema document 1100 if the metadata acquisition policy 800 in FIG. 8 indicates that existing documents should use the latest metadata value. Entry 830 includes a property that states to apply updated metadata to existing documents if the document is mutable, meaning the document is in a lifecycle state which allows it to be changed. As a result, existing documents in the CMS repository that are mutable and that include the schema_number attribute are automatically changed to reflect the new schema_number 5.0, while existing documents in the CMS repository that are immutable will still point to the old version of the schema_number. Note, however, all new documents of the docbook type will have the option to select schema number 5.0 because it will have been added to the attribute definition's possible values list.

A content management system allows a CMS administrator to select elements in an external data source as a source of data for an attribute defined in a specified document type in the CMS. The CMS retrieves the values from the selected elements and populates a picklist with those values. When a user is authoring a document of that specified document type, the picklist of the values may be presented to the user, who may then select one of the values in the picklist. A policy may specify to automatically update documents that include the attribute when the value in the external data source changes. This allows a content management system to specify external data sources as the source of values of attributes in documents, and to perform specified functions when the value in the external data source changes.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims. For example, while the examples in the figures and discussed above related to XML documents, the disclosure and claims herein expressly extend to content management systems that handle any suitable type of content, whether currently known or developed in the future.

What is claimed is:

1. An apparatus comprising:
at least one processor;
a memory coupled to the at least one processor; and
a content management system residing in the memory and executed by the at least one processor, the content management system comprising:
an external metadata acquisition mechanism that retrieves metadata for a specified document type in the content management system from a data source external to the content management system.

2. The apparatus of claim 1 wherein the external data source comprises a web page, and the metadata comprises an element in the web page.

3. The apparatus of claim 1 further comprising a metadata acquisition policy corresponding to an attribute defined in the metadata, the policy specifying at least one criterion that determines whether changes to values in the external data source should be automatically reflected in corresponding documents in the content management system that are of the specified document type.

4. The apparatus of claim 3 wherein the external metadata acquisition mechanism, when the metadata acquisition policy specifies that changes to values in the external data source should be automatically reflected in corresponding documents in the content management system that are of the specified document type, automatically changes at least one document of the specified document type in the content management system that contains the attribute when a value for the attribute in the external data source changes.

5. The apparatus of claim 1 wherein the external metadata acquisition mechanism allows an administrator to browse the external data source and select at least one element in the external data source as the metadata.

6. The apparatus of claim 5 wherein the external metadata acquisition mechanism retrieves at least one value from the selected at least one element and populates a list of possible values for an attribute in the specified document type with the at least one value.

7. A computer-implemented method for defining an attribute for a document of a specified document type in a content management system, the method comprising the steps of:
(A) identifying at least one element in a data source external to the content management system as corresponding to the attribute;
(B) retrieving a value for the attribute from the external data source; and
(C) assigning the value to the attribute in the document.

8. The method of claim 7 wherein the external data source comprises a web page, and the metadata comprises an element in the web page.

9. The method of claim 7 further comprising a metadata acquisition policy corresponding to an attribute defined in the metadata, the policy specifying at least one criterion that determines whether changes to values in the external data source should be automatically reflected in corresponding documents in the content management system.

10. The method of claim 9 further comprising the step of, when the metadata acquisition policy specifies that changes to values in the external data source should be automatically reflected in corresponding documents in the content management system, automatically changing at least one document in the content management system that contains the attribute when a value for the attribute in the external data source changes.

11. The method of claim 7 further comprising the step of allowing an administrator to browse the external data source and select at least one element in the external data source as the metadata.

12. The method of claim 11 further comprising the steps of:
retrieving at least one value from the selected at least one element; and
populating a list of possible values for an attribute in the document with the at least one value.

13. A method for deploying computing infrastructure, comprising integrating computer readable code into a computing system, wherein the code in combination with the computing system perform the method of claim 7.

14. A computer-implemented method for defining metadata for an attribute in a document of a specified document type in a content management system, the method comprising the steps of:
(A) allowing an administrator to identify at least one element in a data source external to the content management system as corresponding to the attribute;
(B) retrieving at least one value for the attribute from at least one element in the external data source;
(C) populating a list of possible values for the attribute with the at least one value;
(D) allowing a user to select from the list of possible values a value for the attribute;
(E) reading a metadata acquisition policy corresponding to the attribute that specifies that changes to at least one value in the external data source should be automatically reflected in corresponding documents in the content management system;
(F) periodically checking the at least one value in the external data source for changes; and
(G) when a change in the at least one value is found in step (F), automatically updating the attribute in at least one document of the specified document type to reflect the change in the at least one value.

15. An article of manufacture comprising:
(A) a content management system comprising:
an external metadata acquisition mechanism that retrieves metadata for a specified document type in the content management system from a data source external to the content management system; and
(B) computer-readable media bearing the content management system.

16. The article of manufacture of claim 15 wherein the external data source comprises a web page, and the metadata comprises an element in the web page.

17. The article of manufacture of claim 15 further comprising a metadata acquisition policy corresponding to an attribute defined in the metadata, the policy specifying at least one criterion that determines whether changes to values in the external data source should be automatically reflected in corresponding documents in the content management system.

18. The article of manufacture of claim 17 wherein the external metadata acquisition mechanism, when the metadata acquisition policy specifies that changes to values in the external data source should be automatically reflected in corresponding documents in the content management system, automatically changes at least one document in the content management system that contains the attribute when a value for the attribute in the external data source changes.

19. The article of manufacture of claim 15 wherein the external metadata acquisition mechanism allows an administrator to browse the external data source and select at least one element in the external data source as the metadata.

20. The article of manufacture of claim 19 wherein the external metadata acquisition mechanism retrieves at least one value from the selected at least one element and populates a list of possible values for an attribute in the document with the at least one value.
